(19) United States
(12) Patent Application Publication
(10) Pub. No.: US 2012/0102797 A1
(43) Pub. Date: May 3, 2012

(54) LED ASSEMBLY HAVING IMPROVED DISCERNIBILITY, AN ATTACHMENT METHOD FOR THE SAME, AND A SIGNBOARD AND TRAFFIC SAFETY DISPLAY BOARD TO WHICH THE SAME HAS BEEN ATTACHED

(76) Inventor: Jae Yong Heo, Seoul (KR)

(21) Appl. No.: 13/266,653

(22) PCT Filed: Mar. 2, 2010
(86) PCT No.: PCT/KR10/01285

§ 371 Date: Oct. 27, 2011

(30) Foreign Application Priority Data
Feb. 27, 2009 (KR) 10-2009-0016791
Mar. 27, 2009 (KR) 10-2009-0026408
Mar. 31, 2009 (KR) 10-2009-0027808

(51) Int. Cl. G09F 13/00; G09F 15/00; F21V 3/00

(52) U.S. Cl. 40/541; 362/235

(57) ABSTRACT

The present invention relates to an LED assembly and products using the same. More specifically, the present invention relates to an LED assembly having improved discernibility from the far distance and near distance and from the front and sides, which is covered with a light-passing unit having a thin-film light-passing part and a thick-film light-passing part such that scattering of light is prevented and in which the light irradiation range is specified by the size of the light-passing unit such that light can penetrate far from the thin-film light-passing part but, even so, glare directly in front of the front surface of the LED is softened and, because the medium in the thick-film light-passing part is thick, some of the light passing through the medium is reflected on the inside and the light can also reach the side surfaces. The present invention also relates to signboards and traffic safety display boards using the LED assembly.

### TECHNICAL FIELD

The present invention relates to an LED assembly and products using the same. More specifically, the present invention relates to an LED assembly, an attaching method of the LED assembly, and signboards and traffic safety display boards using the LED assembly having improved discernibility from the far distance and near distance and from the front and sides, which is covered with a light-passing unit having a thin-film light-passing part and a thick-film light-passing part such that scattering of light is prevented and in which the light irradiation range is specified by the size of the light-passing unit such that light can penetrate far from the thin-film light-passing part but, even so, glare directly in front of the front surface of the LED is softened and, because the medium in the thick-film light-passing part is thick, some of the light passing through the medium is reflected on the inside and the light can also reach the side surfaces.

### BACKGROUND ART

Signboards or traffic safety display boards should attract public gaze and make a deep impression on people's minds. However, conventional signboards or traffic safety display boards have characters and figures simply printed thereon, and do not properly perform the aforementioned functions. In a case where a lightening system is installed in some of the signboards or traffic safety display boards, the lightening system performs only a function of allowing the simply printed characters or figures to be well seen, but does not perform other functions except the function.

Traffic safety display boards or signboards having LEDs attached thereto have appeared. However, since the LED emits light forward and the light emitted from the LED has a property of advancing straight, the glare of intense light occurs due to a relatively large quantity of light reaching just the front of the LED. Further, the light is hardly emitted from sides of the LED, and therefore, it is not easy to recognize the light emitted from the sides of the LED. Since the light irradiation range of the LED is extremely limited, a plurality of LEDs should be used when it is necessary to light a wide area. Therefore, the traffic safety display boards or signboards having the LEDs attached thereto do not properly perform their functions.

### DISCLOSURE OF INVENTION

### Technical Problem

Embodiments provide an LED assembly, an attaching method of the LED assembly, and signboards and traffic safety display boards using the LED assembly having improved discernibility and shapability from the far distance and near distance, which is covered with a light-passing unit having a thin-film light-passing part and a thick-film light-passing part such that scattering of light is prevented and in which the light irradiation range is specified by the size of the light-passing unit such that light can penetrate far from the thin-film light-passing part but, even so, glare directly in front of the front surface of the LED is softened and, because the medium in the thick-film light-passing part is thick, some of the light passing through the medium is reflected on the inside and the light can also reach the side surfaces.

### Technical Solution

According to an aspect of the present invention, there is provided an LED assembly with improved discernibility, including: at least one LED; a light-passing unit configured to surround an emission part of the LED and transmit light of the LED to an outside thereof; and a fixing part positioned on a bottom surface of the LED, wherein the light-passing unit includes at least one thin-film light-passing part of which thickness is thin in the light-passing unit so as to ease the glare of intense light just in front of the LED and to improve discernibility at a far distance, and at least one thick-film light-passing part of which thickness is thicker than that of the thin-film light-passing part in the light-passing unit so as to emit the light to sides of the LED by widely diffusing the light of the LED.

The LED assembly may further include a support platform positioned at a lower part of the LED and adhered closely to a side surface of the light-passing unit.

A protection wall for protecting the LED around the LED may be mounted to the support platform or the fixing part.

A light diffusion cap for surrounding the LED may be formed at an outside of the LED, a lower part of the light diffusion cap may be coupled to the fixing part, the light diffusion cap may have a shape in which a thin wall is formed along a side of the LED from the bottom of the fixing part, and a convex, concave or flat lens for light diffusion may be then formed above the LED.

A polycarbonate layer may be additionally attached to a top of the light-passing unit.

A concave part of which diameter is relatively small may be formed in the light-passing unit.

A diffusion layer may be additionally attached to an inside of the light-passing unit, opposite to a top of the LED.

At least one air exhaustion groove or embossing may be formed on a side surface of the light-passing unit, which comes in contact with the LED.

According to an aspect of the present invention, there is provided a signboard using LED assemblies with improved discernibility, including: a main body on which contents to be communicated are displayed; a plurality of LED assemblies according to claims 1 to 8; a control unit configured to control the LED assemblies; and a power supply unit configured to supply power to the LED assemblies.

The main body may include a channel part having an internal space formed therein and a cover part for covering the top of the channel part so as to three-dimensionally display characters, numbers or figures, and the LED assemblies may be installed in the internal space of the channel part.

The main body may include a channel part having an internal space formed therein and a cover part for covering the top of the channel part so as to three-dimensionally display characters, numbers or figures, and the LED assemblies may be mounted on the outer surface of the cover part.

The main body may include a channel part having an internal space formed therein so as to three-dimensionally display characters, numbers or figures, and the LED assemblies may be installed in the internal space of the channel part.

The main body may include a protruding part protruded to have a predetermined height and made of an elastic material and a finishing part positioned on the top of the protruding part, and the LED assemblies may be mounted on the outer surface of the finishing part.

A folding means as an attaching means for attaching the main body to a fixture may be attached to a side of the main body, and the main body may be adhered closely to the fixture by the folding means.

A moving means as an attaching means for attaching the main body to a fixture may be attached to the main body, and the main body may be pushed into the fixture.

According to an aspect of the present invention, there is provided a traffic safety display board using LED assemblies with improved discernibility, including: a main body on which information to be provided to drivers and pedestrians is printed; and at least one LED assembly described above attached to the main body.

The traffic safety display board may further include a lower support having an attachable/detachable to the main body and having a high and low control function and a folding function so as to conveniently carry the traffic safe display board.

The main body may be a triangular emergency display board.

The lower support may be a tripod in which three support legs are combined with a central portion, each of the three support legs may have a high and low control means for individually performing high and low control and a folding means for convenient carrying, and an attachable/detachable weight reinforcing member may be mounted to a part of each of the three support legs, which comes in contact with the ground.

An auxiliary display board facing the front may be attached in the middle of the support legs.

At least one LED assembly described above is attached to the auxiliary display board.

The traffic safety display board may further include a rod-shaped connecting rod having one end connected to the main body and the other end connected to the lower support. The lower support may be provided with a magnet or cubic.

The connecting rod may be provided with an attaching/detaching means easily attachable/detachable to/from the lower support and the main body.

The connecting rod may be provided with a high and low control means for performing high and low control.

The connecting rod may be provided with an angle adjusting means for adjusting an angle of the connecting rod to front and rear.

In an attaching method of the LED assembly with improved discernibility, the light-passing unit is positioned on an insertion hole of a main body, and the light-passing unit is attached to the main body by inserting the protection wall and the fixing part, combined with the LED, into the light-passing unit from a lower part of the insertion hole.

In an attaching method of the LED assembly with improved discernibility, the light-passing unit is attached to a main body by inserting the concave part into an insertion hole of the main body.

### Advantageous Effects

In the LED assembly with improved discernibility according to the present invention, although one LED with the same power as the conventional LED assembly is used, it is easy to recognize light of the LED not only at far distance but also front and sides at near distance, thereby improving discernibility and shapability. Particularly, glare of intense light in front of the LED can be eased, and light of LED can be easily recognized at sides of the LED.

In the signboard and traffic safety display board according to the present invention, an LED assembly having thin-film and thick-film light-passing parts is used, so that discernibility at far/near distance and front and sides can be improved as compared with the conventional signboard or traffic safety display board. Thus, contents to be communicated can be quickly and precisely provided, thereby obtain a remarkable advertisement effect.

Since two or more light can be expressed with only one LED assembly by equalizing or differentiating the color of light of the LED and the color of a light-passing unit or by differentiating the thicknesses of the thin-film and thick-film light-passing parts, the signboard according to the present invention can emit fantastic light so as to make a deep impression on people's minds, thereby maximizing the advertisement effect.

In the traffic safety display board according to the present invention, light emitted from the LED passes through the light-passing unit, so that it is possible to prevent visual fields of drivers and pedestrians from be instantaneously interrupted by intense light of the LED.

The traffic safety display board with improved discernibility according to the present invention is attached by simply putting the traffic safety display board on a part to be installed using a magnet or cubic, so that the traffic safety display board can be quickly and simply installed.

Since the conventional traffic display board has its volume or weight, users cannot conveniently carry or move the conventional traffic display board. However, the traffic safety display board according to the present invention is manufactured using a material with high flexibility, so that users can carry and move the traffic safety display board, and the traffic safety display board is not damaged by a physical impact. Thus, it is possible to reduce users' burdens on damage in dealing of the traffic safety display board.

### DESCRIPTION OF DRAWINGS

FIG. 1 is a sectional view used in the present invention.

FIG. 2 is a sectional view of the LED assembly having a light diffusion cap formed therein.

FIG. 3 is a sectional view of the LED assembly having a polycarbonate layer attached thereto.

FIG. 4 is a sectional view of the LED assembly having a diffusion layer attached thereto.

FIGS. 5 and 6 are sectional views showing embodiments of the LED assembly having a concave part formed therein.

FIG. 7 is a sectional view showing another embodiment of the LED assembly.

FIG. 8 is a sectional view of the LED assembly having a support platform additionally mounted therein.

FIG. 9 is a schematic sectional view of the LED assembly having a protection wall additionally mounted therein.

FIG. 10 is a sectional view of the LED assembly having two air exhaustion groves formed therein.

FIG. 11 is a cross-sectional view taken along line A-A of FIG. 10.

FIG. 12 is a sectional view of the LED assembly having embossings formed therein.

FIG. 13 is an exemplary view of a signboard with improved discernibility according to the present invention.

FIG. 14 is an exploded perspective view of a channel signboard according to an embodiment of the present invention.

FIG. 15 is an exploded perspective view of a channel signboard according to another embodiment of the present invention.

FIG. 16 is an exploded perspective view of a channel signboard according to still another embodiment of the present invention.

FIG. 17 is a front perspective view of a skashi (character) signboard according to an embodiment of the present invention.

FIG. 18 is a rear perspective view of the skashi (character) signboard according to the embodiment of the present invention.

FIG. 19 is a perspective view of a folding signboard according to an embodiment of the present invention.

FIG. 20 is a schematic view of a moving signboard according to an embodiment of the present invention.

FIG. 21 is an enlarged perspective view of part A in FIG. 20.

FIG. 22 is a schematic view of an emergency display board with improved discernibility according to an embodiment of the present invention.

FIG. 23 is a schematic view of an emergency display board according to another embodiment of the present invention.

FIG. 24 is a schematic view showing an embodiment of a lower support.

FIG. 25 is a schematic view of the emergency display board having an auxiliary display board mounted thereto according to the present invention.

FIG. 26 is a schematic view of an emergency display board according to still another embodiment of the present invention.

FIG. 27 is a perspective view showing an auxiliary fixing means and an angle adjusting means.

FIG. 28 is a schematic view showing a state that emergency display boards are mounted to an actual vehicle according to the present invention.

### MODE FOR INVENTION

FIG. 1 is a sectional view of an LED assembly used in the present invention. As shown in FIG. 1, the LED assembly 100 according to the present invention includes a light-passing unit 10 and a fixing part 30. Hereinafter, each part will be described.

The shape of the LED used in the present invention is not particularly limited. For example, the emission part of the LED may be long as shown in FIG. 1, and the emission part of the LED may be short. In a case where the emission part of the LED is short, the brightness at sides of the LED may be more intense as compared with FIG. 1. Further, in a case where the emission part of the LED is short, the shape of the light-passing unit may be changed depending on the shape of the emission part of the LED. In addition, it will be apparent that an LED of which emission part has a short but wide shape and an LED having a round shape may be applied to the present invention.

The number of LEDs used in the present invention is at least one. Here, the number of LEDs is not particularly limited. In a case where a plurality of LEDs are mounted in the LED assembly, the LEDs having different colors may be mounted in the LED assembly. Further, the LEDs may be mounted at different angles from one another in the LED assembly. This is provided to improve discernibility at various angles in consideration of the straightness of light emitted from the LEDs.

The light-passing unit 10 surrounds the emission part of the LED 1 and transmits light of the LED 1 to the outside thereof. The light-passing unit has a flat bottom surface. The light-passing unit 10 prevents light from scattering and limits light irradiation range to the size of the light-passing unit, so as to increase the degree of concentration of light, to reflect various expressions of light according to the shape of the light-passing unit, and to enable several colors, shapes and brightnesses to be expressed in one LED assembly. Since the light-passing unit 10 surrounds the emission part of the LED 1, the light-passing unit functions to protect the LED 1 from an external impact applied to the LED 1. Light emitted from the LED 1 is emitted to the outside of the LED assembly through the light-passing unit 10. While passing through the light-passing unit 10, the light is reflected, diffracted and the like. In the present invention, the shape of the light-passing unit 10 is not particularly limited. However, in order to more improve discernibility, the light-passing unit 10 preferably includes at least one thin-film light-passing part 12 and at least one thick-film light-passing part 14.

The thin-film light-passing part 12 is a thin part of the light-passing unit so as to cast the light of the LED 1 up to a long distance, particularly to ease the glare of intense light just in front of the LED. The thick-film light-passing part 14 is a part thicker than the thin-film light-passing part 12 in the light-passing unit so as to highlight the shape of the light-passing unit by widely spreading the light of the LED 1 so that light is easily recognized even at sides of the LED 1. In the thin-film light-passing part 12, the thickness of a medium through which the light of LED 1 passes is thin, and therefore, almost of the light passes through the thin-film light-passing part without loss of energy. Thus, people at a relatively long distance can recognize the light emitted from the thin-film light-passing part 12. Further, a thin film exists in the thin-film light-passing part 12, and therefore, it is possible to ease the glare of intense light just in front of the front side of the LED.

The thickness of the thin-film light-passing part 12 is changed depending on the brightness of the LED mounted in the LED assembly. In a general LED, the thickness of the LED is preferably 0.1 to 10 mm. If the thickness of the LED is less than 0.1 mm, the glare of intense light occurs just in front of the LED. If the thickness of the LED exceeds 10 mm, it is difficult to case light of the LED up to a long distance because the light is interrupted by the light-passing unit.

The thin-film light-passing part 12 casts light to a long distance and ease the glare of intense light just in front of the LED, thereby improving the entire discernibility of the LED assembly.

The thin-film light-passing part 12 may be formed by making a hole in the inside of the light-passing unit 10 so that the light-passing unit with the hole is thinner than its surroundings or by forming a part from which light is intensely emitted on the outer surface of the light-passing unit to be thinner than its surroundings.

In FIG. 1, the thin-film light-passing part 12 has a flat shape when being viewed from a side of the thin-film light-passing part. However, the thin-film light-passing part may have a convex shape in which light can be diffused or a concave shape in which light can be gathered.

The thick-film light-passing part 14 is a part thicker than the thin-film light-passing part 12 in the light-passing unit. Since a medium of the thick-film light-passing part is thick, a part of the light passing through the medium is reflected in the inside of the thick-film light-passing part so that the light is spread throughout the entire of the thick-film light-passing part 14 and emitted to the outside of the light-passing unit. Thus, the light emitted from the thick-film light-passing part 14 is darker than that emitted from the thin-film light-passing part 12, but is entirely spread, so that it is possible to recognize the shape of the light-passing unit not only in front of the front side of the LED 1 but also at sides of the LED 1.

As a result, the light emitted from the thin-film light-passing part 12 is casted in a direction of the front side of the LED 1 up to a long distance, so that it is possible to enable people at the long distance to easily recognize the light and to ease the glare of intense light just in front of the front side of the LED. Accordingly, it is possible to recognize the light of the LED 1 at a short distance, particularly just in front of the LED, without the fatigue of eyes. The light emitted from the thick-film light-passing part 14 is also emitted to the sides of the LED 1, so that people can easily recognize the shape of the light-passing unit event at the sides of the LED 1, thereby improving the shapability of the LED assembly. The light emitted from the thin-film light-passing part 12 is bright, and the light emitted from the thick-film light-passing part 14 is gentle so that the thin-film and thick film light-passing parts 12 and 14 are harmonized, thereby obtaining a remarkable visual effect.

The thickness of the thick-film light-passing part 14 is not particularly limited. However, the thick-film light-passing part is preferably 1.5 to 20 times thicker than the thin-film light-passing part 12 so that light is emitted to the sides of the LED. If the thickness of the thick-film light-passing part exceeds 20 times, the amount of the light emitted to the outside is too small.

The position of each of the thin-film and thick film light-passing parts 12 and 14 is not particularly limited. However, the thin-film light-passing part 12 is preferably formed at the front side that is a direction in which the light of LED 1 is most intensely emitted, in consideration of the straightness of light, so that the light emitted from the thin-film light-passing part is casted up to a long distance. The thick film light-passing part 14 is preferably mounted around the thin-film light-passing part 12.

The number of each of the thin-film and thick film light-passing parts 12 and 14 is not particularly limited, and several thin-film and thick film light-passing parts 12 and 14 may be formed as occasion demands.

The entire shape of the light-passing unit 10 is not particularly limited. In FIG. 1, the light-passing unit has a tetrahedral shape, but may have various three-dimensional shapes such as trihedral, pentahedral, hexahedral and hemispheric shapes. The shape of each of the thin-film and thick film light-passing parts 12 and 14 when being viewed from the top is not particularly limited. The shape of each of the thin-film and thick film light-passing parts is generally a circle, but may be the shape of a specific figure or character including a star, a triangle, a square, an animal pattern, a person's figure, a character pattern, and the like. In this case, the shape of a figure or character formed in the thin-film or thick film light-passing part 12 or 14 can be recognized from the outside.

Since the thin-film light-passing part 12 means a part of which thickness is relatively thin in the light-passing unit, the thin-film light-passing part 12 may be implemented using a method of forming the light-passing unit and then engraving a part corresponding to the thin-film light-passing part 12. Since the thick-film light-passing part 14 means a part of which thickness is relatively thick in the light-passing unit, the thin-film light-passing part 12 may be implemented using a method of forming the light-passing unit and then embossing a part corresponding to the thin-film light-passing part 12. Further, a plurality of thin-film and thick-film light-passing parts may be implemented by properly combining of embossing and engraving.

The thin-film or thick film light-passing part 12 or 14 may be coated with a color so as to emphasize the visible effect of the LED assembly. Here, the thin-film and thick film light-passing parts 12 and 14 may be coated with the same color or different colors. The thin-film and thick film light-passing parts 12 and 14 may be simultaneously coated with several colors. Only the outer parts of the thin-film and thick film light-passing parts 12 and 14 may be coated with a color. Light emitted from one LED may be variously expressed by allowing the colors of the LED and the light-passing unit to be identical to or different from each other.

The material of the light-passing unit 10 is not particularly limited, and may be a modable and permeable material. For example, the material of the light-passing unit may be glass, plastic, silicon, latex, rubber, urethane, resin, epoxy resin, polycarbonate, polymer, or the like. Among these materials, the silicon with excellent moldability and strong anti-impact ability is most preferably used.

The thin-film or thick-film light-passing part may be variously formed by combining at least one of transparent, translucent and opaque materials.

The fixing part 30 is a part positioned on bottom surfaces of the LED 1 and the light-passing unit 10, and functions to attach the LED assembly 100 to a main body 200 and fix the LED. Here, the main body 200 means a part to which the LED assembly is attached in a signboard or traffic safety display board which will be described later. For convenience of illustration, the reference numeral uses 200 that is the reference numeral of a main body of the signboard, but may be 600 that is the reference numeral of the traffic safety display board. As occasion demands, a PCB substrate is positioned at the part, or the part includes the PCB substrate in the inside thereof Although it has been illustrated in this figure that the fixing part 30 has the same diameter as the light-passing unit 10, the diameter of the fixing part may be different from that of the light-passing part as occasion demands.

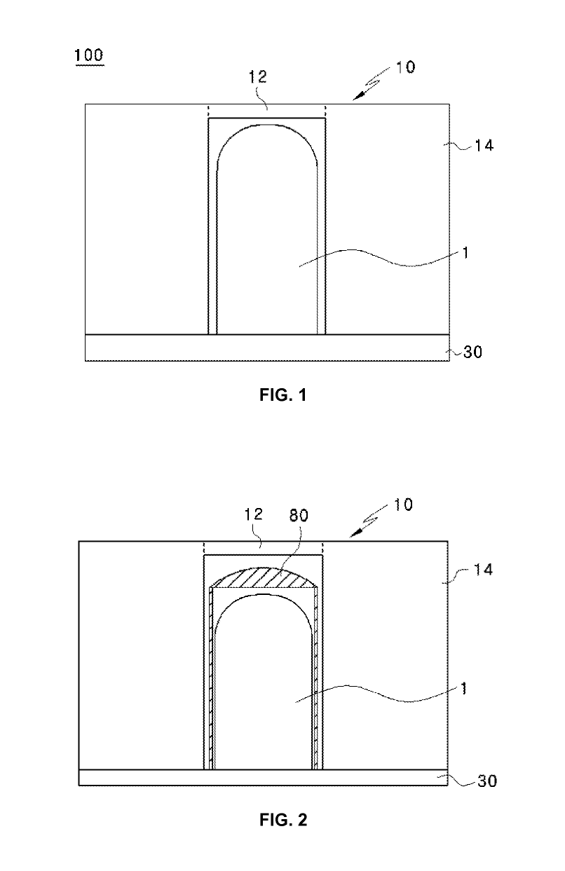

The LED assembly attached to the main body in the present invention may have a light diffusion cap additionally attached thereto so as to improve discernibility at far and near distances. The light diffusion cap may have a convex or concave shape or a flat shape, and maximizes the diffusion and distribution of light of the LED. FIG. 2 is a schematic view of the LED assembly having a light diffusion cap additionally formed therein. The light diffusion cap 80 has a shape surrounding the LED 1, and the bottom of the light diffusion cap 80 is coupled to the fixing part 30. The light diffusion cap has a shape in which a thin wall is formed along a side of the LED 1 from the bottom of the fixing part 30 and a convex, concave or flat lens for light diffusion is then formed above the LED 1. The light diffusion cap 80 may be attached to a protection wall which will be described later. In this case, the light diffusion cap has a shape in which the convex, concave or flat lens for light diffusion is attached to the protection wall. Light emitted from the LED 1 is primarily distributed and secondarily distributed by the thin-film and thick-film light-passing parts positioned at the outside of the light diffusion cap 80.

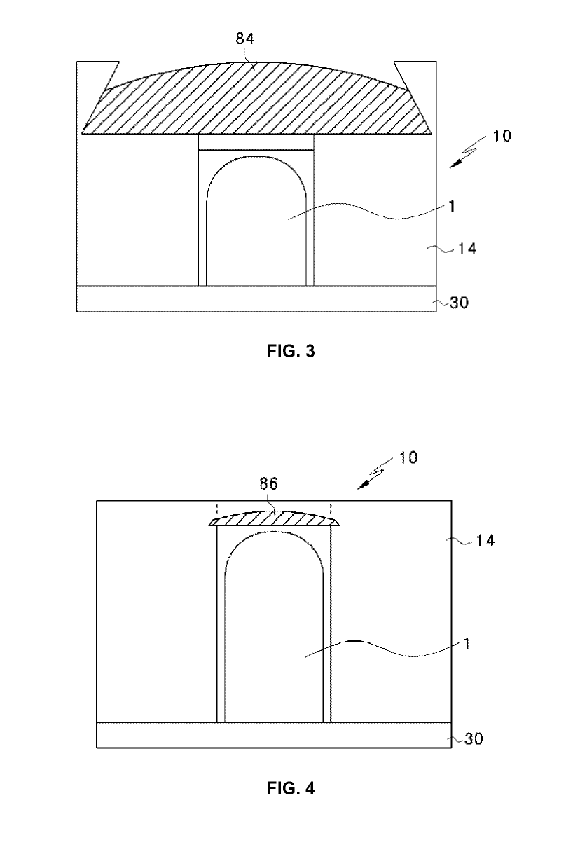

In the LED assembly according to the present invention, a polycarbonate layer may be additionally attached to an upper part of the light-passing unit so as to improve discernibility. Since the polycarbonate layer has high diffusivity of light and high permeability of visible light, the polycarbonate layer radiates light with a very stable feeling. The light primarily diffused through the light-passing unit is changed into light with a stable feeling while being secondarily diffused through the polycarbonate layer, so that the discernibility is entirely improved. FIG. 3 is a sectional view of the LED assembly having the polycarbonate layer attached thereto. As shown in FIG. 3, the polycarbonate layer 84 is attached to an upper part of the light-passing unit 10. The shape of the attached polycarbonate layer 84 is not particularly limited, but an upper part of the polycarbonate layer is preferably formed in the shape of a convex lens for the purpose of diffusion of light. The method of attaching the polycarbonate layer 84 to the light-passing unit is not particularly limited. However, the polycarbonate layer 84 may be simply attached to the light-passing unit by inserting the polycarbonate layer into a groove formed by engraving the upper part of the light-passing unit.

In the LED assembly according to the present invention, a diffusion layer may be additionally attached at a lower part of the light-passing unit facing the top of the LED so as to broadly diffuse light emitted from the LED. FIG. 4 is a sectional view of the LED assembly having a diffusion layer attached thereto. The diffusion layer 86 is made of a material capable of diffusing light as broad as possible. Particularly, the diffusion layer is preferably made of crystal so as to induce diffused reflection. Light primarily diffused by the diffused reflection induced by the diffusion layer 86 is more broadly diffused while passing through the light-passing unit 10, so that the light emission range of the LED assembly having is entirely broadened. The method of attaching the diffusion layer 86 to the light-passing unit 10 is not particularly limited. However, the diffusion layer 86 may be simply attached to the light-passing unit by inserting the diffusion layer into a groove formed in the light-passing unit.

In relation to an attaching method of the main body 200 of the LED assembly 200, the entire LED assembly 100 is integrally formed and then attached to the main body 200, or the LED assembly is formed so that the light-passing unit 10 and the LED 1 are separated from each other and then inserted into the main body 200. In a case where the entire LED assembly is integrally formed, the LED assembly 100 may be attached to the main body 200 in various manners. Here, the attaching method is not particularly limited, but a high-frequency attaching method is most preferably used for the convenience of working process, and the like.

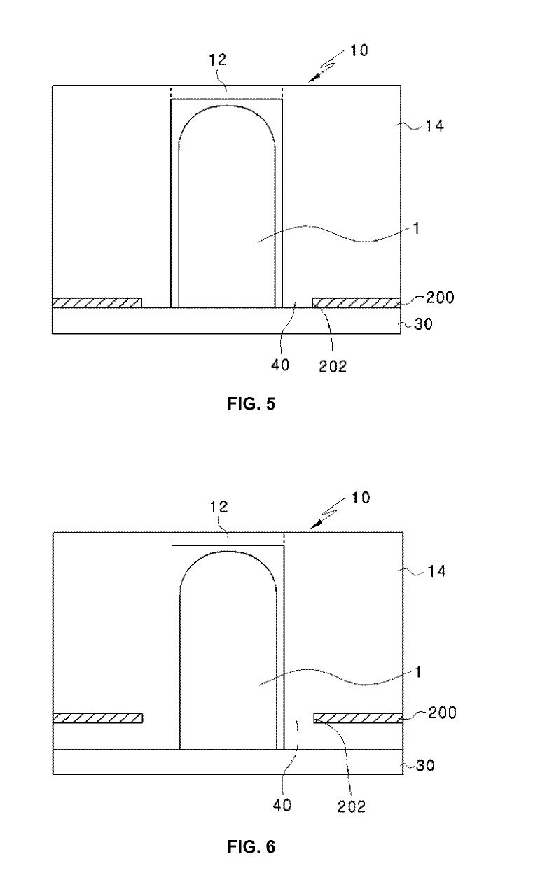

As another attaching method, a plurality of insertion holes 202 are formed at a certain interval in the main body 200, and the LED assembly 100 is inserted into the insertion holes 202. Such a coupling method is generally referred to as a rear insertion method. To this end, the LED assembly 200 necessarily has a shape in which the bottom of the light-passing unit is concave. The concave part has a function of coupling the light-passing unit and the main body to each other, and refers to a shape having a groove which is concave, insertable or supportable. FIGS. 5 and 6 are sectional views showing embodiments of the LED assembly having a concave part formed therein. In the LED assembly 100, a concave part 40 is formed at the bottom of the light-passing unit 10, so that the main body 200 is coupled to a side of the concave part. Since the light-passing unit 10 is made of a soft material, the light passing unit is inserted into the insertion hole 202. The concave part 40 may be positioned at the lowermost part of the light-passing unit 10 as shown in FIG. 5, but may be formed in the middle of the light-passing unit. The main body is fixed to the concave part.

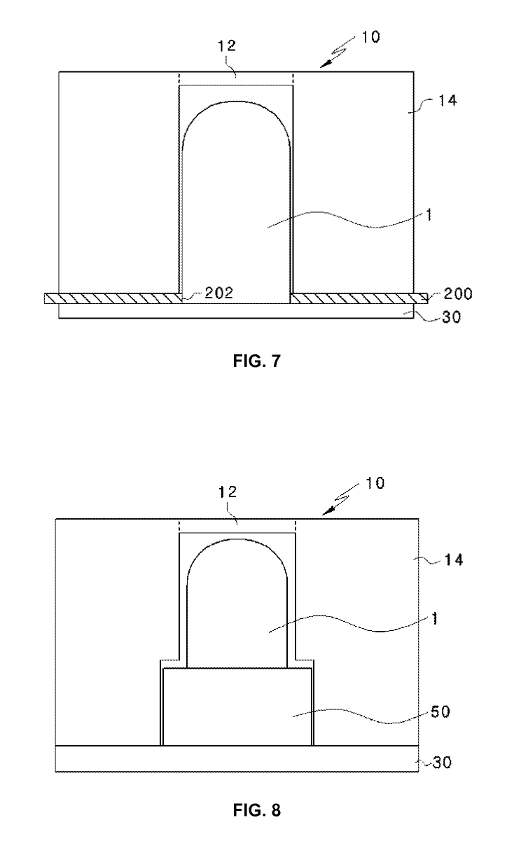

In a case where the light-passing part 10 and the LED 1 are separated from each other, as shown in FIG. 7, the insertion hole 202 is formed in the main body, and the light-passing unit 10 is disposed on the insertion hole 202. Then, the LED 1 and the light-passing unit 10 are coupled with each other by inserting the LED 1 into the insertion hole from the lower part to the upper part of the insertion hole. Such a coupling method is generally referred to as a front insertion method, and a product is fixed between the light-passing unit and the fixing part. In this case, the LED 1 and the light-passing unit 10 are adhered closely to each other. On the contrary, the LED 1 may be first inserted into the lower part of the insertion hole 202 and then coupled to the light-passing unit 10 at the upper part of the insertion hole 202.

A protection wall which will be described later may be mounted at the outside of the LED 1, and may be mounted to the fixing part 30. In this case, the protection wall and the fixing part are coupled to the light-passing unit 10 by being inserted into the insertion hole at the lower part of the main body.

In order to intensify the strength of the coupling, a support platform 50 may be additionally mounted to the fixing part of the LED 1 using a supporting method using a groove or screw for support. The support platform 50 is a part completely adhered to closely to the light-passing unit 10 so as to allow the LED 1 to be completely fixed in the light-passing unit 10 and prevent damage caused by vibration of the LED 1. FIG. 8 is a sectional view of the LED having a support platform additionally mounted thereto. As shown in FIG. 8, the support platform 50 is completely adhered closely to the side of the light-passing unit 10.

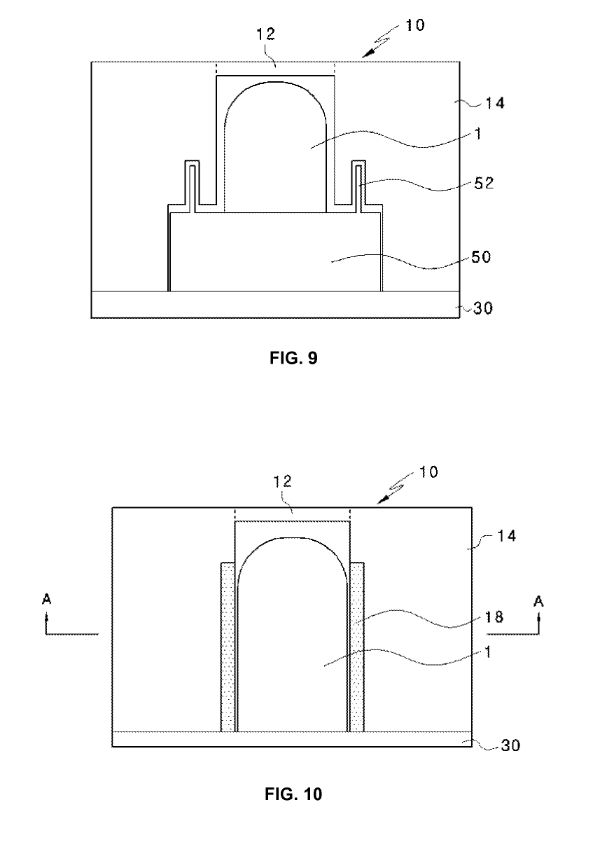

FIG. 9 is a schematic view of the LED assembly having a protection wall additionally mounted therein. As shown in FIG. 9, the diameter of the support platform 50 is greater than that of the LED 1, and the protection wall 52 for protecting the LED 1 around the LED 1 may be mounted on the support platform 50. The protection wall 52 is formed in a circular shape around the LED so as to prevent the LED 1 from being easily damaged due to an external impact when an emergency display board using the LED assembly used in the present invention falls down due to wind or the like. Here, the protection wall 52 does not necessarily surround the entire LED 1. The protection wall functions to allow the light-passing unit to be coupled thereto and fix the light diffusion cap. In a case where the support platform does not exist, the protection wall may be immediately extended from the fixing part 30.

In the process of inserting the LED 1 into the light-passing unit 10, air in a part of the light-passing unit 10, into which the LED 1 is inserted, is compressed as the LED 1 is inserted into the light-passing unit. Therefore, when the LED assembly is used for a long period of time, the LED is pushed by the compressed air, and accordingly, the LED 1 and the light-passing unit 10 may be separated from each other. In the present invention, an air exhaustion means may be formed in the inside of the light-passing unit 10 so as to solve such a problem.

In the present invention, the air exhaustion means may be an air exhaustion groove 18 or embossing 19. FIG. 10 is a sectional view of the LED assembly having two air exhausting grooves formed therein. FIG. 11 is a cross-sectional view taken along line A-A of FIG. 10. As shown in FIG. 10, at least one groove is formed in the insertion direction of the LED 1 at a part at which the inside of the light-passing unit 10 comes in contact with the LED 1. The air exhaustion groove 18 allows the air in the inside of the light-passing unit 10 to be exhausted to the outside in the process of inserting the LED 1 into the light-passing unit.

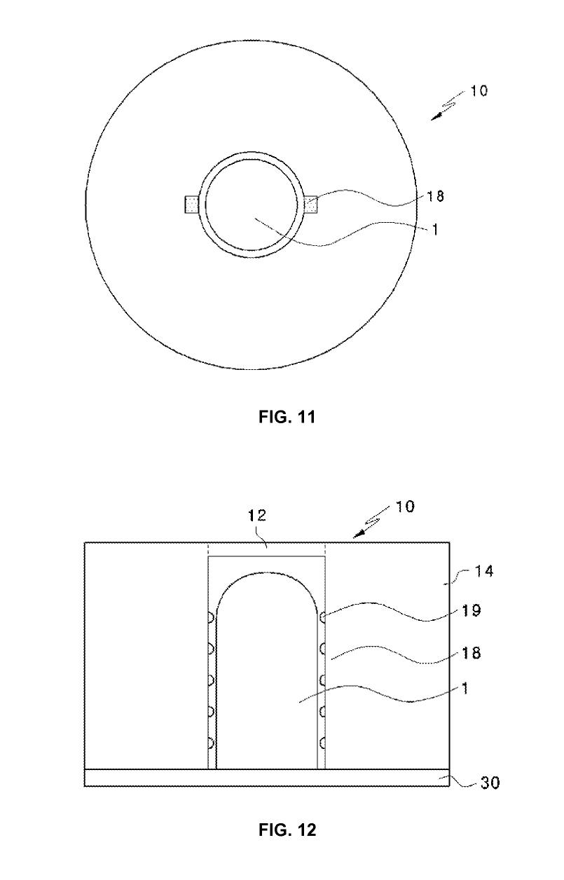

FIG. 12 is a sectional view of the LED assembly having embossings formed therein. As shown in FIG. 12, at least one embossing is formed at the part at which the inside of the light-passing unit 10 comes in contact with the LED 1. In the process of inserting the LED 1 into the light-passing unit, the air in the inside of the light-passing unit 10 is exhausted to the outside through a space between the embossings 19 so as to prevent excessive compressed air from being formed in the inside of the light-passing unit. Here, the air exhaustion groove 18 or embossing 19 may be formed not only at the side of the LED but also at the side of the support platform as occasion demands.

In the LED assembly of the present invention, a reflection plate is formed on the bottom surface of the light-passing part 10, so that light emitted from the LED can be reflected to the front of the LED, thereby more improving discernibility.

Hereinafter, products using the LED assemblies with improved discernibility according to the present invention will be described. Signboards and traffic safety display boards may be used as the products using the LED assemblies according to the present invention. First, signboards will be described.

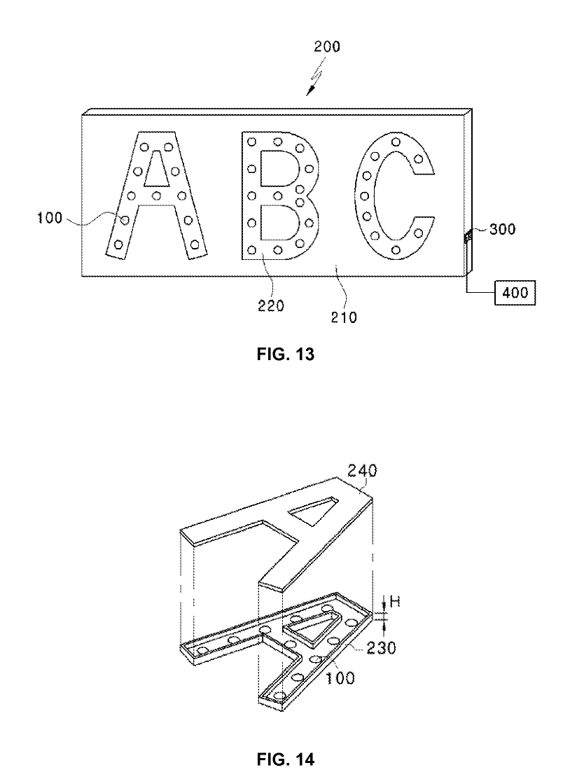

FIG. 13 is an exemplary view of a signboard with improved discernibility according to the present invention. As shown in FIG. 13, the signboard with improved discernibility includes LED assemblies 100, a main body 200 of the signboard, a control unit 300 and a power supply unit 400.

The main body 200 of the signboard is a main body part of the signboard according to the present invention. The main body 200 of the signboard means one generally referred to as a signboard in the current street. The main body of the signboard is not particularly limited. Contents to be generally communicated are displayed in the main body 200 of the signboard, and the LED assembly 100 is necessarily attached to a necessary part. Specific examples of the main body 200 of the signboard will be described in detail with reference to the following embodiments.

The LED assembly 100 is the LED assembly described above, and therefore, its detailed description will be omitted.

The control unit 300 is a part for controlling the flickering of the LED assembly, and may include a switch, a control circuit and the like. The control unit is generally a part frequently used for signboards using a luminous body, and therefore, its detailed description will be omitted.

The power supply unit 400 is a part for supplying power for the emission and control of LEDs. The power supply unit is not particularly limited. For example, the power supply unit may be at least one of an electric condenser, a battery, a DC power source, a solar cell and a hybrid. Particularly, the signboard with improved discernibility according to the present invention has small power consumption, and thus it is suitable to use the solar cell or hybrid.

Hereinafter, embodiments of the present invention will be described based on the specific shape of the signboard.

### Embodiment 1: Flex Signboard

The flex signboard is a signboard in which a flex is covered as a cover on a frame made of steel or aluminum, and contents to be communicated is printed on the outside of the flex. A plurality of fluorescent lamps may be installed in the inside of the flex.

FIG. 13 is a perspective view of a flex signboard according to an embodiment of the present invention. As shown in FIG. 13, in the flex signboard according to the present invention, a film 210 made of a flexible material is covered on a main body 200 configured as a frame, and characters 220 or images are printed on the outside of the film. LED assemblies 100 are attached along each of the characters 220 using a high-frequency attaching method.

### Embodiment 2: Channel Signboard (1)

The channel signboard is a signboard having improved discernibility by protruding a part to be emphasized, such as a character or figure, so as to have a three-dimensional effect and installing a lightening system in the inside of the character or figure. FIG. 14 is an exploded perspective view of a channel signboard according to an embodiment of the present invention. As shown in FIG. 14, a main body of the channel signboard includes a channel part 230 having a space formed in the inside thereof and a cover part 240 for covering the top of the channel part 230, a character, number or figure is displayed by combining the channel part 230 and the cover part 240. Only the character ‘A’ in FIG. 13 is shown in FIG. 14. Here, the combination of the channel part 230 and the cover part 240 may be performed using an adhesive or the like. This is also performed using a method generally used by those skilled in the art. In the embodiment 2, the LED assemblies according to the present invention installed in the inside of the channel part 230.

In a conventional channel signboard, the bottom of a channel part having a luminous body installed therein and a cover part are necessarily spaced apart from at a predetermined distance H or longer, and therefore, the channel part necessarily has the predetermined height. If the distance between the luminous body and the cover part is short, a part having intense light and a part having weak light exist at the same time.

However, in the present invention, light is primarily diffused by the light-passing unit 10 in the LED assembly that is a luminous body and then reaches the cover part 240, and thus the height H can be smaller than that in the conventional channel signboard. Further, although a smaller number of LED assemblies are installed as compared with the conventional channel signboard, the channel signboard according to the present invention can obtain an effect identical or superior to that of the conventional channel signboard, as the light is diffused in the light-passing part.

The manufacturing cost of the conventional channel signboard is generally divided into installation costs of the channel part and the luminous body, in which the rate of each of the installation costs is 50%. On the other hand, in the channel signboard according to the present invention, the height H of the channel part is lowered, so that it is possible to save the cost of raw materials and decrease the number of luminous bodies, thereby obtaining an entire installation saving effect of 50% or so.

Since the maintenance cost of the channel signboard is less than that in the conventional channel signboard, power consumption is also decreased, and thus the entire maintenance cost is less than that in the conventional signboard.

Embodiment 3: Channel Signboard (2)

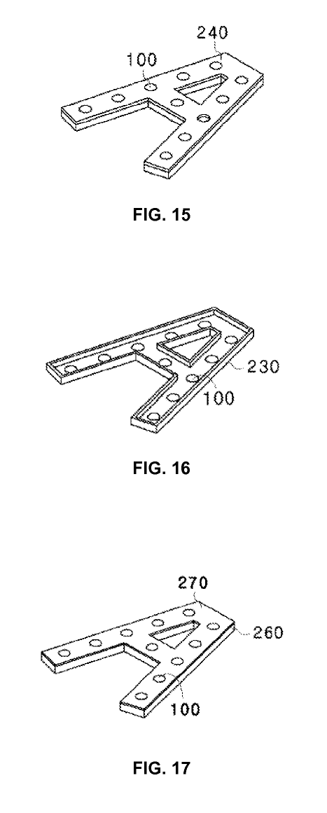

FIG. 15 is a perspective view of a channel signboard according to another embodiment of the present invention. The embodiment 3 is identical to the embodiment 2. However the embodiment 3 is different from the embodiment 2 in that the LED assemblies 100 are mounted on the outside surface of the cover part 240. Accordingly, the channel signboard can be used by attaching the LED assemblies 100 to the outside of the cover part while maintaining the conventional channel signboard as it is. In the embodiment 3, grooves are punched in the cover part made of polycarbonate, lexan, acryl or the like, and the LED assemblies according to the present invention are then mounted in the respective grooves. In this embodiment, the LED assembly that is a luminous body is not attached to the inside of the channel part but attached to the outside of the channel part so as to improve the brightness of light fixed in the inside of the channel part. Thus, the light is emitted directly to the outside from an external finishing material of the channel part, thereby obtaining a new type of LED signboard with remarkably improved discernibility.

### Embodiment 4: Channel Signboard (3)

FIG. 16 is a perspective view of a channel signboard according to still another embodiment of the present invention. The channel signboard of the embodiment 4 is different from the embodiments 2 and 3 in that only the channel part exists but the cover part does not exist. In this embodiment, basic components are identical to those of the embodiment 2, and therefore, their detailed descriptions will be omitted.

### Embodiment 5: Skashi (Character) Signboard

The skashi (character) signboard is similar to the channel signboard, but includes a protruding part and a finishing part. The protruding part is protruded to have a predetermined height from the surface of a wall, and is frequently made of an elastic material. The finishing part is positioned at the top of the protruding part, and is made of a metal material.

The skashi (character) signboard generally has a non-illumination form. However, the LED assemblies according to the present invention are mounted in a space formed in the inside of a skashi (character), thereby obtaining a new type of signboard having illumination inserted therein.

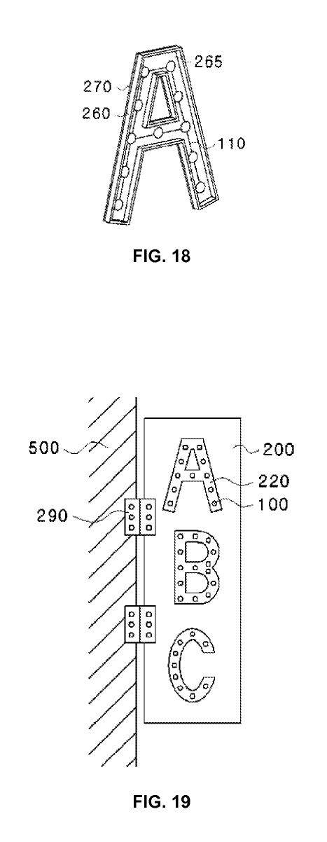

FIG. 17 is a front perspective view of a skashi (character) signboard according to an embodiment of the present invention. FIG. 18 is a rear perspective view of the skashi (character) signboard according to the embodiment of the present invention. As shown in FIG. 17, the skashi (character) signboard includes a protruding part 260 and a finishing part 270, and LED assemblies 100 are mounted on the surface of the finishing part 270. As shown in FIG. 18, grooves 265 are formed in the inside of the protruding part 260 so as to attach the LED assemblies to the finishing part 270, and electric wires 110 for the LED assemblies 100 are installed in the grooves 265.

### Embodiment 6: Folding Signboard

The folding signboard is a signboard usually fixed and protruded from a fixture such as a wall. Since a folding means such as a hinge is attached to a fixing part with a wall, the folding signboard can be placed close to the fixture using the folding means as occasion demand. That is, the folding means as an attaching means for attaching a main body of the signboard to the fixture is attached to a side of the main body of the signboard. FIG. 19 is a perspective view of a folding signboard according to an embodiment of the present invention. As shown in FIG. 19, a main body 200 of the folding signboard is fixed to a wall 500 by a hinge 290 that is a folding means, and characters 220 are displayed on the main body 200 of the signboard. LED assemblies are attached along each of the characters 220. If necessary, the main body 200 of the signboard may be placed close to the wall using the hinge. Here, the main body 200 of the signboard may have a shape described in the embodiments 1 to 6 described above.

### Embodiment 7: Moving Signboard

The moving signboard according to the present invention is fixed to a fixture such as a wall. The moving signboard is not completely fixed to the fixture, but attached to the fixture by a moving means such as a rail. Thus, if the signboard pushed into the inside of the fixture, the signboard is not seen from the outside. If the signboard is pulled to the outside of the fixture, the signboard is seen from the outside. Here, the moving means is not limited, and generally has a shape such as a sliding door. That is, the moving means as an attaching means for attaching the main body of the signboard to the fixture is attached to the main body of the signboard, and the main body of the signboard can be pushed into the inside of the fixture by the moving means.

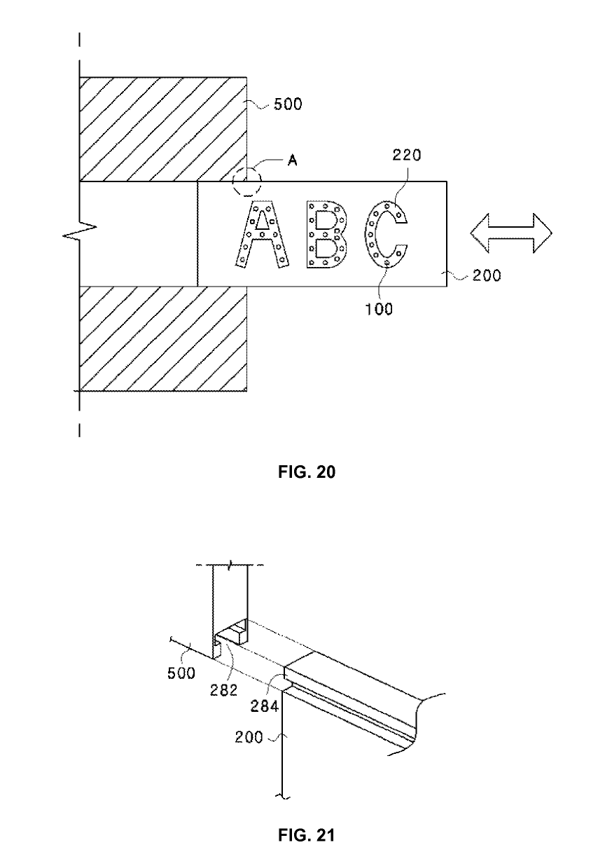

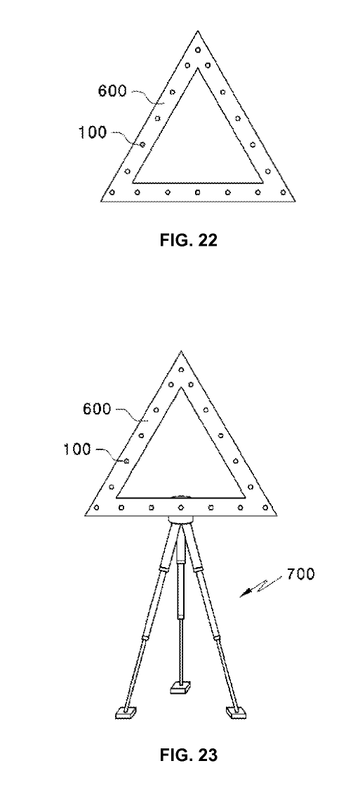

FIG. 20 is a schematic view of a moving signboard according to an embodiment of the present invention. FIG. 21 is an enlarged perspective view of part A in FIG. 20. Characters 220 are displayed on a main body 200 of the moving signboard, and LED assemblies 100 are attached along each of the characters 220. A moving means 280 is formed at the main body 200 of the moving signboard, so that the moving signboard can be seen or cannot be seen from the outside as occasion demands. FIG. 21 shows an embodiment of the moving means, which includes a groove 282 formed in a fixture 500 and a projection 284 formed at the main body 200 as a shape capable of being coupled to the groove. Here, the main body 200 may have a shape described in the embodiments 1 to 6 described above.

Next, traffic safety display boards will be described. The traffic safety display board according to the present invention includes a main body and at least one LED assembly attached to the main body. Here, the main body is a part on which information to be provided to drivers and pedestrians are printed. A triangular emergency display board is representative of the traffic safety display board. In addition, the traffic safety display board may include an octagonal display board for stop, a circular display board for suspension of traffic, a rectangular display board for direction of movement, and the like. Hereinafter, the present invention will be described based on an emergency display board.

FIG. 22 is a schematic view of an emergency display board with improved discernibility according to the present invention. As shown in FIG. 22, the emergency display board with improved discernibility according to the present invention includes a main body 600 and a plurality of LED assemblies attached on the main body 600.

The main body 600 has a triangular shape generally used in the emergency display board, and may have a foldable shape as occasion demands. The main board 600 is generally purchased in the market. A fixing means of the main body 600 is not related to the present, and therefore, its detailed description will be omitted.

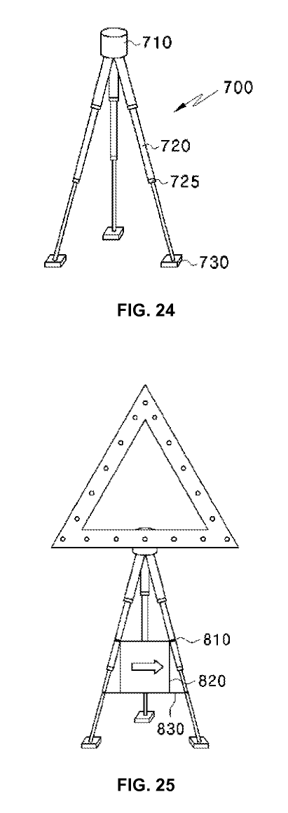

FIG. 23 is a schematic view of an emergency display board according to another embodiment of the present invention. FIG. 24 is a schematic view showing an embodiment of a lower support. As shown in FIGS. 23 and 24, the emergency display board according to this embodiment is formed by coupling a lower support 700 to a lower part of the emergency display board of FIG. 22. That is, the emergency display board of this embodiment includes a lower support 700 of which high and low control is possible and an emergency display board attachable/detachable to the lower support. Hereinafter, only the lower support will be described.

The emergency display board is generally disposed on a front ground at a place where an accident or the like occurs. Generally, a human being well recognizes a thing placed at the level of its eyes. However, since a conventional emergency display board is disposed at the ground, the conventional emergency display board is disposed at a place lower than a driver's visual field. Therefore, it is difficult to recognize the emergency display board at a far distance. In order to solve such a problem, in the present invention, the emergency display board is disposed higher than the ground using the lower support so that the emergency display board can be disposed at a place higher than the ground.

The lower support 700 is not particularly limited, and a general tripod with which three support legs 720 are combined based on a central part 710 is preferably used as the lower support. Here, each of the support legs 720 has a high and low control means 275 for high and low control, and a attachable/detachable weight reinforcing member 730 may be mounted to a part of each of the support legs, which comes in contact with the ground. The lower support also has a folding function for the purpose of convenient carrying

The high and low control means 275 is not particularly limited, and may be one that can generally perform the high and low control. For example, a threaded fastener frequently used in the current market may be used as the high and low control means.

In the present invention, the weight of the emergency display board is increased using the lower support, and hence the emergency display board does not easily fall down due to wind. However, the weight reinforcing member 730 may be additionally mounted to the part of each of the support legs 720, which comes in contact with the ground, so as to prevent the emergency display board from falling down due to strong wind. Since the weight reinforcing member 730 can endure wind with a certain strength, the weight reinforcing member necessarily has a certain weight. Therefore, a metal, sand bottle, water bottle or the like may be used as the weight reinforcing member. In the case of the metal, the weight reinforcing member has a shape attachable to the lower part of the support legs 720, and thus, the weight reinforcing member is fixed using a method of inserting the weight reinforcing member into the lower part of each of the support legs or attaching the weight reinforcing member to the lower part of each of the support legs. In the case of the sand or water bottle, sand, soil or water can be obtained in the vicinity of the place where the emergency display board is positioned and then filled in the inside of the sand or water bottle, so that the sand or water bottle can be easily moved and kept.

The central part 710 of the lower support is a part with which the three support legs 720 are combined. The central part 710 is provided with a means through which the emergency display board is attachable to or detachable from the lower support. The central part necessarily has a means for controlling an angle left, right, up and down, like the general tripod, and accordingly, the emergency display board can be disposed at an appropriate angle under a road situation. It is sufficient that the central part 710 is one frequently used in a general camera tripod or the like.

Since the emergency display board positioned at the top of the lower support can be attached to or detached from the lower support, the emergency display board is used by being separated from the lower support in moving or keeping, and the emergency display board is used by being coupled to the lower support only in installation on the road. An attaching/detaching means and angle adjusting means mounted in the central portion uses ones used in the tripod as they are, and therefore, their detailed descriptions will be omitted.

In addition to the emergency display board, an auxiliary display board 820 for providing additional information may be mounted to the support legs 720. The auxiliary display board 820 is attached among the three support legs 720 of the lower support 700, and an attaching means may be a rubber band, tape, adhesive, string or the like. FIG. 25 is a schematic view of the emergency display board having an auxiliary display board mounted thereto according to the present invention. As shown in FIG. 25, the auxiliary display board 820 is attached to the support legs 720 by an attaching means 810 such as a rubber band. In addition, the auxiliary display board is attached to the support legs 720 as occasion demands.

Various materials such as cloth, paper, plastic, wood and metal plate may be used as the auxiliary display board, and contents to be communicated is printed on the auxiliary display board. Here, the LED assemblies described above may be attached to the auxiliary display board so as to ensure discernibility of the contents to be communicated.

The main board 600 and the support legs 720 of the lower support 700 are coated with a luminous paint, so that drivers can more easily recognize the emergency display board.

A triangle frame constituting the main body 600 may be individually assembled so that the moving and keeping of the main body can be conveniently performed. This has been previously known in the art, and therefore, its detailed description will be omitted.

Meanwhile, the emergency display board according to the present invention may be attached to an inside of the trunk door of a vehicle so that the emergency display board can be seen from the rear when the trunk door of the vehicle is opened. In a case where an accident occurs, a driver simply opens the trunk door of the vehicle without taking a separate action, so that the driver can inform rear drivers and pedestrians of the accident.

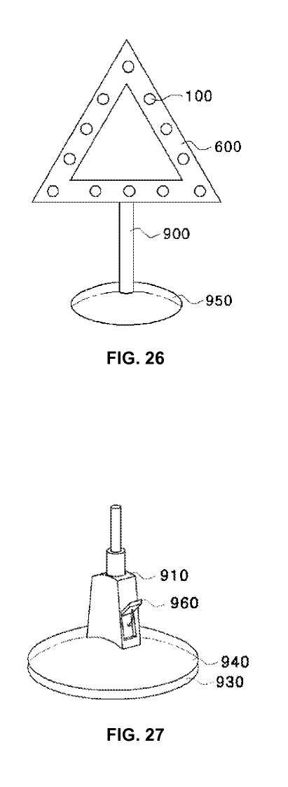

Next, still another embodiment of the emergency display board according to the present invention will be described. FIG. 26 is a schematic view of the emergency display board according to still another embodiment of the present invention. As shown in FIG. 26, the emergency display board includes a main body 600, a connecting rod 900 and a lower support 950.

The main body 600 is identical to the embodiment described above, and therefore, its description will be omitted.

The connecting rod 900 is formed in the shape of a rod. One end of the connecting rod is connected to the lower support 950, and the other end of the connecting rod is connected to the main body 600. It is sufficient that the connecting rod has an appropriate length. However connecting rod may have a high and low control means for convenience of carrying and keeping. That is, the connecting rod may be configured to have one rod as shown in FIG. 25, but may be configured by combining two rods. It is sufficient that the high and low control means is one generally used in the market, such as a tripod for camera.

The lower support 950 includes a simple attaching/detaching means such as a magnet or cubic in the inside thereof, so that the installation of the lower support can be completed by putting the lower support on the trunk of a vehicle, a top of the vehicle, a window of the vehicle or an adjacent object in emergency. An angle adjusting means for adjusting an angle up and down is preferably mounted at a part of the lower support coupled to the connecting rod.

In a case where the cubic is used as the attaching/detaching means, the attaching/detaching means is preferably provided with an auxiliary fixing means mounted to a top of the cubic so as to reinforcing the coupling force with the vehicle or object fixed to the vehicle. FIG. 27 is a perspective view showing an auxiliary fixing means and an angle adjusting means. As shown in FIG. 27, the angle adjusting means 910 is placed at a position connected to the connecting rod 900, and the connecting rod 900 can be controlled front and back by the angle adjusting means. The auxiliary fixing means includes a fixing lever 960 attached to the top of a cubic 930 and an auxiliary absorption plate 940 for allowing the cubic 930 to be adhered closely to an attachment surface or separated from the attachment surface as the fixing lever 960 is operated up and down. The auxiliary fixing means and the angle adjusting means may be ones frequently used for a holding platform of a navigation system for vehicle. In FIG. 27, the lower support is formed in a circular shape, but may be formed in various shapes such as a square shape.

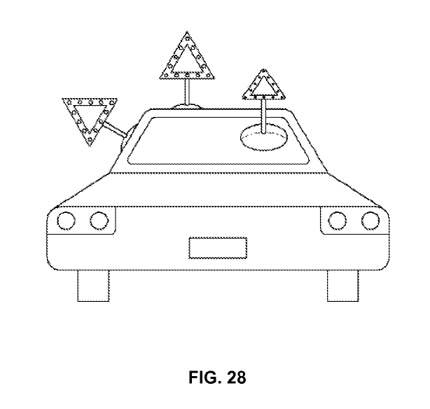

FIG. 28 is a schematic view showing a state that emergency display boards are mounted to an actual vehicle according to the present invention. As shown in FIG. 28, the emergency display board according to the present invention can be conveniently and quickly installed by simply putting the emergency display board on the top or trunk of the vehicle. The emergency display means can be controlled so as to be well seen from the rear using the angle adjusting means according to the installation position of the emergency display board.

### INDUSTRIAL APPLICABILITY

The LED assembly with improved discernibility according to the present invention can be used for various products, particularly signboards or traffic safety display boards.

Although the present invention has been described in detail in connection with the specific embodiments, it will be readily understood by those skilled in the art that various modifications and changes can be made thereto within the technical spirit and scope of the present invention. It is also apparent that the modifications and changes fall within the scope of the present invention defined by the appended claims.

1. An LED assembly with improved discernibility, comprising:
at least one LED;
a light-passing unit configured to surround an emission part of the LED and transmit light of the LED to an outside thereof; and
a fixing part positioned on a bottom surface of the LED,
wherein the light-passing unit comprises at least one thin-film light-passing part of which thickness is thin in the light-passing unit so as to ease the glare of intense light just in front of the LED and to improve discernibility at a far distance, and at least one thick-film light-passing part of which thickness is thicker than that of the thin-film light-passing part in the light-passing unit so as to emit the light to sides of the LED by widely diffusing the light of the LED.

2. The LED assembly of claim 1, further comprising a support platform positioned at a lower part of the LED and adhered closely to a side surface of the light-passing unit.

3. The LED assembly of claim 2, wherein a protection wall for protecting the LED around the LED is mounted to the support platform or the fixing part.

4-5. (canceled)

6. The LED assembly of claim 1, wherein a concave part of which diameter is relatively small is formed in the light-passing unit.

7. (canceled)

8. The LED assembly of claim 1, wherein at least one air exhaustion groove or embossing is formed on a side surface of the light-passing unit, which comes in contact with the LED.

9-15. (canceled)

16. A traffic safety display board using LED assemblies with improved discernibility, comprising:
a main body on which information to be provided to drivers and pedestrians is printed; and
at least one LED assembly according to claim 1 attached to the main body.

17. The traffic safety display board of claim 16, further comprising a lower support having an attachable/detachable to the main body and having a high and low control function and a folding function so as to conveniently carry the traffic safe display board.

18. The traffic safety display board of claim 16, wherein the main body is a triangular emergency display board.

19. The traffic safety display board of claim 17, wherein the lower support is a tripod in which three support legs are combined with a central portion, each of the three support legs has a high and low control means for individually performing high and low control and a folding means for convenient carrying, and an attachable/detachable weight reinforcing member is mounted to a part of each of the three support legs, which comes in contact with the ground.

20. The traffic safety display board of claim 19, wherein an auxiliary display board facing the front is attached in the middle of the support legs.

21. An LED assembly with improved discernibility, comprising:
at least one LED;
a light-passing unit configured to surround an emission part of the LED and transmit light of the LED to an outside thereof; and
a fixing part positioned on a bottom surface of the LED,
wherein the light-passing unit comprises at least one thin-film light-passing part of which thickness is thin in the light-passing unit so as to ease the glare of intense light just in front of the LED and to improve discernibility at a far distance, and at least one thick-film light-passing part of which thickness is thicker than that of the thin-film light-passing part in the light-passing unit so as to emit the light to sides of the LED by widely diffusing the light of the LED,
wherein an auxiliary display board facing the front is attached in the middle of the support legs, and wherein at least one LED assembly is attached to the auxiliary display board.

22. The traffic safety display board of claim 16, further comprising a rod-shaped connecting rod having one end connected to the main body and the other end connected to the lower support,
wherein the lower support is provided with a magnet or cubic.

23. The traffic safety display board of claim 22, wherein the connecting rod is provided with an attaching/detaching means easily attachable/detachable to/from the lower support and the main body.

24. The traffic safety display board of claim 22, wherein the connecting rod is provided with a high and low control means for performing high and low control.

25. The traffic safety display board of claim 22, wherein the connecting rod is provided with an angle adjusting means for adjusting an angle of the connecting rod to front and rear.

26-27. (canceled)
